(19) United States
(12) Patent Application Publication
(10) Pub. No.: US 2011/0319094 A1
(43) Pub. Date: Dec. 29, 2011

(54) INFORMATION PROCESSING APPARATUS, INFORMATION PROCESSING SYSTEM, INFORMATION PROCESSING METHOD, AND PROGRAM

(75) Inventors: TAKASHI USUI, Tokyo (JP); SHINICHIRO ABE, Tokyo (JP); MASAYUKI TAKADA, Tokyo (JP); NAOKI IDE, Tokyo (JP); MASATO ITO, Tokyo (JP); KOHTARO SABE, Tokyo (JP)

(73) Assignee: Sony Corporation, Tokyo (JP)

(21) Appl. No.: 13/161,856

(22) Filed: Jun. 16, 2011

(30) Foreign Application Priority Data
Jun. 24, 2010 (JP) 2010-143650

(51) Int. Cl. H04W 24/00

(52) U.S. Cl. 455/456.1

(57) ABSTRACT

There is provided an information processing apparatus including: a positioning unit acquiring positioning information on a latitude and longitude showing a position of the positioning unit; a transmission unit transmitting a time-series log, which includes the positioning information acquired by the positioning unit, to a server; a reception unit receiving an activity model showing an activity state of a user, the activity model being obtained by a learning process carried out by the server based on the time-series log; a recognition unit recognizing a present activity state of the user using the positioning information acquired by the positioning unit and the activity model received by the reception unit; and a prediction unit predicting behavior of the user from the present activity state of the user recognized by the recognition unit.

### BACKGROUND OF THE INVENTION

1. Field of the Invention

The present invention relates to an information processing apparatus, an information processing system, an information processing method, and a program.

2. Description of the Related Art

In recent years, it has become possible for an information processing apparatus such as a PC or a mobile telephone to detect position information using a GPS (Global Positioning System) or mobile telephone network antenna or the like and realize a variety of services using such position detecting function.

As one example, GPS units are now provided even in mobile telephones, so that in addition to guiding users in the same way as a car navigation system, it has become possible to provide a variety of information relating to a destination, as well as event information, coupons, and the like.

At present, mobile telephones usually obtain such information by having a user designate an area and searching surrounding area information based on the user's area designation.

For example, Japanese Laid-Open Patent Publication No. 2005-315885 proposes a technology that uses an information device that is capable of sensing position information, such as a car navigation system, a mobile telephone, or a PDA, to accumulate a movement history for the user, to predict a movement destination from the movement history, and to acquire information relating to the predicted movement destination using a network or the like. As another example, Japanese Laid-Open Patent Publication No. 2008-204040 proposes a technology that provides the user with information using an information device, such as a car navigation system or PDA, that is capable of detecting position information.

### SUMMARY OF THE INVENTION

However, with the technologies according to both Publication Nos. 2005-315885 and 2008-204040, a movement history is accumulated and all of the past movement history that has been accumulated is used when predicting a movement destination and/or a movement route. This means that for an information processing apparatus such as a mobile telephone, there is the problem that the processing load is high when making a prediction using all of the past movement history. Due to such high processing load, there is the further problem of reduced battery life for the information processing apparatus. There is yet another problem in that when a prediction is made using all of the past movement history, a large amount of memory is used, resulting in limitations over other processes, such as browsing or viewing video, that are carried out while the prediction is being made.

Reduced battery life and limitations over other processing represent the problem of a significant drop in the functioning of an information processing apparatus.

Meanwhile, although it would be conceivably possible to carry out the prediction process on the server side, there would be the problem that it would not be possible to carry out prediction when there is deterioration in the state of wireless communication between the information processing apparatus and the server and the information processing apparatus has entered an area where communication is not possible.

The present invention was conceived in view of such problems and aims to provide an information processing apparatus, information processing system, information processing method, and program, which are novel and improved, and which are capable of providing information desired by the user without a large increase in the processing load and even when there has been deterioration in the wireless communication state.

According to an embodiment of the present invention, there is provided an information processing apparatus including a positioning unit acquiring positioning information on a latitude and longitude showing a position of the positioning unit, a transmission unit transmitting a time-series log, which includes the positioning information acquired by the positioning unit, to a server, a reception unit receiving an activity model showing an activity state of a user, the activity model being obtained by a learning process carried out by the server based on the time-series log, a recognition unit recognizing a present activity state of the user using the positioning information acquired by the positioning unit and the activity model received by the reception unit, and a prediction unit predicting behavior of the user from the present activity state of the user recognized by the recognition unit.

The time-series log may include information on a wireless communication state of wireless communication between the information processing apparatus and the server.

The transmission unit may be operable to transmit the latest time-series log to the server when it is recognized, based on the activity model previously received by the reception unit, that wireless communication is possible between the information processing apparatus and the server.

The reception unit may be operable to receive the latest activity model when it is recognized, based on the activity model previously received by the reception unit, that wireless communication is possible between the information processing apparatus and the server.

The time-series log may include operation information of the user of the information processing apparatus.

The information processing apparatus may further include an information reception unit receiving information that is desired by the user based on the activity state of the user and has been gathered by the server using the activity model, and an information deciding unit using the positioning information acquired by the positioning unit and the information desired by the user received by the information reception unit to decide information to be provided to the user out of the information desired by the user received by the information reception unit.

The information deciding unit may also use a prediction result of the prediction unit to decide, as the information to be provided to the user, information relating to a destination or a location en route to a destination of the user out of the information desired by the user received by the information reception unit.

The time-series log may include information on a wireless communication state of wireless communication between the information processing apparatus and the server. And the information reception unit may be operable to receive the latest information desired by the user when it is recognized, based on the activity model previously received by the reception unit, that wireless communication is possible between the information processing apparatus and the server.

The information processing apparatus may further include a setting unit setting a communication schedule so that information desired by the user is acquired when it is recognized, based on the activity model previously received by the reception unit, that wireless communication is possible between the information processing apparatus and the server.

The reception unit may receive an activity model which shows the activity state of the user and has been obtained by a learning process by the server based on a time-series log including positioning information acquired by a positioning unit of another information processing apparatus.

According to another embodiment of the present invention, there is provided an information processing system including an information processing apparatus and a server. The information processing apparatus may include a positioning unit acquiring positioning information on a latitude and longitude showing a position of the positioning unit, a transmission unit transmitting a time-series log, which includes the positioning information acquired by the positioning unit, to the server, a reception unit receiving an activity model showing an activity state of a user, the activity model being obtained by a learning process carried out by the server based on the time-series log, a recognition unit recognizing a present activity state of the user using the positioning information acquired by the positioning unit and the activity model received by the reception unit, and a prediction unit predicting behavior of the user from the present activity state of the user recognized by the recognition unit. And the server may include a server-side reception unit receiving the time series log transmitted from the transmission unit, a learning unit learning, as an activity model, an activity state of the user who carries the information processing apparatus based on the time series log received by the server-side reception unit, and a server-side transmission unit transmitting the activity model obtained by the learning unit to the information processing apparatus.

According to another embodiment of the present invention, there is provided an information processing method including steps of acquiring, by an information processing apparatus, positioning information on a latitude and longitude showing a position of the information processing apparatus, transmitting, by the information processing apparatus, a time-series log, which includes the acquired positioning information, to a server, receiving, by the server, the transmitted time series log, learning, by the server, as an activity model, an activity state of the user who carries the information processing apparatus based on the received time series log, transmitting, by the server, the obtained activity model to the information processing apparatus, receiving, by the information processing apparatus, the transmitted activity model, recognizing, by the information processing apparatus, a present activity state of the user using the acquired positioning information and the received activity model, and predicting, by the information processing apparatus, behavior of the user from the recognized present activity state of the user.

According to another embodiment of the present invention, there is provided a program for causing a computer to function as a positioning unit acquiring positioning information on a latitude and longitude showing a position of the positioning unit, a transmission unit transmitting a time-series log, which includes the positioning information acquired by the positioning unit, to a server, a reception unit receiving an activity model showing an activity state of a user, the activity model being obtained by a learning process carried out by the server based on the time-series log, a recognition unit recognizing a present activity state of the user using the positioning information acquired by the positioning unit and the activity model received by the reception unit, and a prediction unit predicting behavior of the user from the present activity state of the user recognized by the recognition unit.

According to the embodiments of the present invention described above, it is possible to provide information desired by the user without a large increase in the processing load and even when a network state of wireless communication is poor.

### BRIEF DESCRIPTION OF THE DRAWINGS

FIG. 1 is a block diagram showing the overall configuration of a behavior prediction system according to a first embodiment of the present invention;

FIG. 2 is a block diagram showing one example of a hardware configuration of the behavior prediction system;

FIG. 3 is a sequence chart of a behavior prediction process executed by the behavior prediction system in FIG. 1;

FIG. 4 is a block diagram showing the overall configuration of a behavior prediction system according to a second embodiment of the present invention;

FIG. 5 is a sequence chart of a behavior prediction process executed by the behavior prediction system in FIG. 4 for a case where the behavior prediction system includes one mobile terminal and one server;

FIG. 6 is a sequence chart of a behavior prediction process executed by the behavior prediction system in FIG. 4 for the case where the behavior prediction system includes two mobile terminals and one server;

FIG. 7 is a block diagram showing the overall configuration of a behavior prediction system according to a third embodiment of the present invention;

FIG. 8 is a sequence chart of a behavior prediction process executed by the behavior prediction system in FIG. 7 for the case where the behavior prediction system 140 includes one mobile terminal and one server;

FIG. 9 is a sequence chart of a behavior prediction process executed by the behavior prediction system in FIG. 7 for the case where the behavior prediction system 140 includes two mobile terminals and one server;

FIG. 10 is a diagram useful in explaining one example of a time-series log;

FIG. 11 is a diagram useful in explaining another example of a time-series log;

FIG. 12 is a diagram useful in explaining yet another example of a time-series log;

FIG. 13 is a diagram useful in explaining one example of predicted position information, predicted time-of-arrival information, and arrival probability information for each destination predicted in step S118;

FIG. 14 is a diagram useful in explaining one example of a screen displayed on a display unit;

FIG. 15 is a diagram useful in explaining one example of a screen displayed on the display unit of a mobile terminal;

FIG. 16 is a diagram useful in explaining one example of the displaying of information provided to the user via display on the display unit of a mobile terminal;

FIG. 17 is a diagram useful in explaining content displayed on the display unit of a mobile terminal;

FIG. 18 is a diagram useful in explaining content displayed on the display unit of a mobile terminal; and

FIG. 19 is a block diagram showing an example configuration of the hardware of a computer that executes a series of processes according to a program.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The following description is given in the order indicated below.

### 1. Behavior Prediction System (First Embodiment)

### 2. Behavior Prediction System (Second Embodiment)

2-1. Behavior Prediction System Including One Mobile Terminal and One Server

2-2. Behavior Prediction System Including Two Mobile Terminals and One Server

### 3. Behavior Prediction System (Third Embodiment)

3-1. Behavior Prediction System Including One Mobile Terminal and One Server

3-2. Behavior Prediction System Including Two Mobile Terminals and One Server

### 1. Behavior Prediction System

### First Embodiment

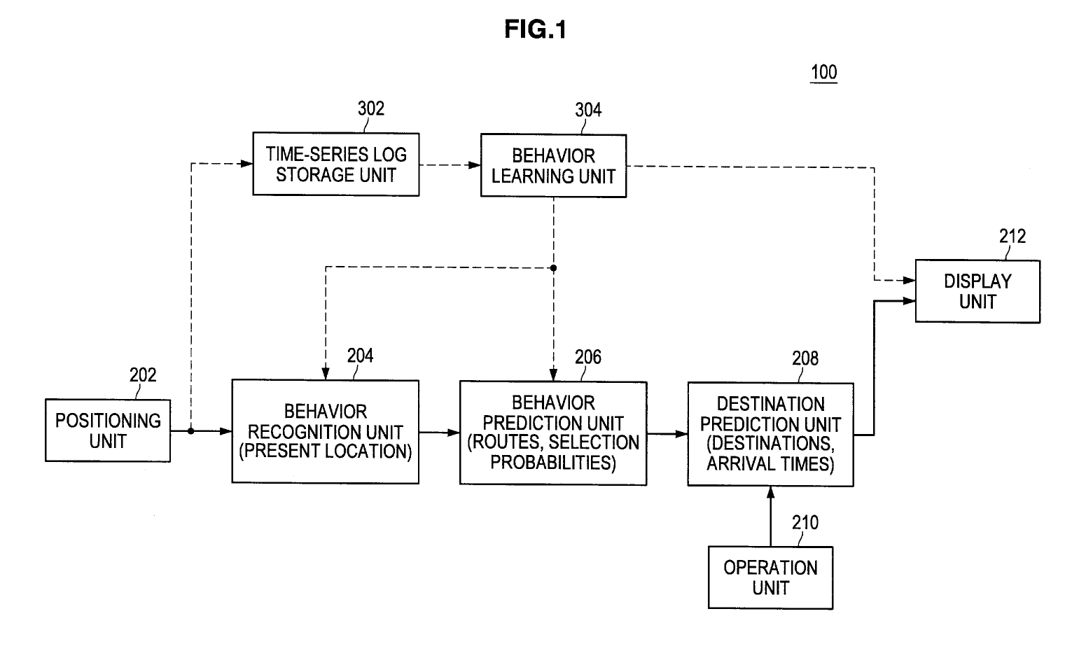

First, a behavior prediction system according to a first embodiment of the present invention will be described. FIG. 1 is a block diagram showing the overall configuration of the behavior prediction system according to the present embodiment.

In FIG. 1, a behavior prediction system 100 includes a positioning unit 202, a time-series log storage unit 302, a behavior learning unit 304, a behavior recognition unit 204, a behavior prediction unit 206, a destination prediction unit 208, an operation unit 210, and a display unit 212.

The behavior prediction system 100 carries out a learning process that learns activity states (states expressing behavior/activity patterns) of the user as a stochastic state transition model from a time series log including positioning information showing a present location acquired by the positioning unit 202, which is a GPS sensor or the like. The behavior prediction system 100 carries out a prediction process that predicts the destination of the user using a stochastic state transition model (user activity model) expressed using parameters obtained by the learning process. In this prediction process, there are cases where not only one destination but a plurality of destinations are predicted. The behavior prediction system 100 calculates arrival probabilities, routes, and arrival times for the predicted destinations and notifies the user of such information.

In FIG. 1, the arrows drawn using dotted lines show the flow of data in the learning process and the arrows drawn using solid lines show the flow of data in the prediction process.

The positioning unit 202 is one example of a “positioning unit” and “transmission unit” for the present invention and successively acquires positioning information for a latitude and longitude showing the position of the positioning unit 202 itself at fixed time intervals (for example, 15-second intervals). Note that there are cases where the positioning unit 202 is not capable of acquiring the positioning information at fixed intervals. For example, when the positioning unit 202 is in a tunnel or underground, there are cases where it is not possible to pick up satellites and the acquisition intervals become longer. In such case, it is possible to supplement the positioning information by carrying out an interpolation process or the like.

In the learning process, the positioning unit 202 supplies a log, which includes the acquired positioning information on the latitude and longitude, to the time-series log storage unit 302. In the prediction process, the positioning unit 202 supplies the acquired positioning information to the behavior recognition unit 204. Also, in the present embodiment, the log entries supplied to the time-series log storage unit 302 include operation information made by the user via the operation unit 210 and wireless communication state information on the communication state between a mobile terminal 200 and a server 300, described later.

The time-series log storage unit 302 stores the log entries, that is, a “time-series log”, including the acquired positioning information successively acquired by the positioning unit 202, the operation information on operations by the user, and the wireless communication state information. To learn the behavior/activity pattern of the user, the time-series log needs to be accumulated for a certain period, such as several days.

Based on the time-series log stored in the time-series log storage unit 302, the behavior learning unit 304 learns, as a stochastic state transition model, an activity state of the user who carries an appliance in which the positioning unit 202 is incorporated. The behavior learning unit 304 is capable of using a log of a certain period in the past. It is also possible to weight the log used in the learning process by the behavior learning unit 304 by applying forgetting coefficients on a daily basis. Since the positioning information in a time series included in the time-series log is data showing the position of the user, the operation information for the user is data showing operations made by the user, and the wireless communication state information is data showing the state of wireless communication, the activity state of the user learned as a stochastic state transition model is a state showing movement paths taken by the user, user operations on such movement paths taken by the user, and the state of a wireless network along the movement paths taken by the user. Since it is possible to use the technology disclosed in Japanese Laid-Open Patent Publication No. 2009-208064, for example, submitted by the present applicant as the learning method, detailed description thereof is omitted here. As the stochastic state transition model used in the learning, it is possible to use a stochastic state transition model including a hidden state, such as Ergodic HMM (Hidden Markov Model), RNN (Recurrent Neural Network), FNN (Feed Forward Neural Network), SVR (Support Vector Regression), and RNNPB (Recurrent Neural Net with Parametric Bias). In the present embodiment, as the stochastic state transition model, Ergodic HMM with sparse constraints is used. Note that since Ergodic HMM with sparse constraints, a method of calculating parameters for Ergodic HMM, and the like are disclosed in Japanese Laid-Open Patent Publication No. 2009-208064 mentioned above, detailed description thereof is omitted here.

The behavior learning unit 304 supplies data showing the learning result to the display unit 212 to have the learning result displayed. The behavior learning unit 304 also supplies parameters of the stochastic state transition model obtained by the learning process to the behavior recognition unit 204 and the behavior prediction unit 206.

The behavior recognition unit 204 is one example of a “reception unit” and a “recognition unit” for the present invention, and uses the stochastic state transition model for the parameters obtained by learning, to recognize the present activity state of the user (that is, a present location of the user) from the positioning information supplied from the positioning unit 202 in real time. The behavior recognition unit 204 supplies a node number of a present state node of the user to the behavior prediction unit 206.

The behavior prediction unit 206 is one example of a “reception unit” and a “prediction unit” for the present invention, and uses the stochastic state transition model for the parameters obtained by the learning to precisely search for (predict) routes that may be taken by the user from the present location of the user shown by the node number of the state node supplied from the behavior recognition unit 204. Also, by calculating the occurrence probability for each of the found routes, the behavior prediction unit 206 predicts a selection probability that is the probability that each of the found routes will be selected. In the present embodiment, the behavior recognition unit 204 and the behavior prediction unit 206 use a maximum likelihood algorithm, a Viterbi algorithm or BPTT (Back-Propagation Through Time), for example.

The destination prediction unit 208 is supplied from the behavior prediction unit 206 with the routes that can be taken by the user and the respective selection probabilities. The destination prediction unit 208 may also be supplied from the operation unit 210 with information showing a destination indicated by the user.

The destination prediction unit 208 uses the stochastic state transition model for the parameters obtained by the learning to predict the destination of the user.

More specifically, the destination prediction unit 208 first lists destination candidates. The destination prediction unit 208 sets places where the recognized behavior state of the user becomes a “visit state” as destination candidates.

After this, out of the listed destination candidates, the destination prediction unit 208 decides destination candidates on the routes found by the behavior prediction unit 206 as destinations.

Next, the destination prediction unit 208 calculates an arrival probability for each decided destination.

When a large number of destinations have been detected, there are cases where displaying all of such destinations would make the display on the display unit 212 difficult to view due to destinations that the user has little possibility of going to being displayed. Accordingly, in the present embodiment, in the same way as when the number of found routes is narrowed down, it is possible to narrow down the destinations to be displayed so as to display a specified number of destinations with a high arrival probability and/or only destinations where the arrival probability is a specified value or higher. Note that the displayed numbers of destinations and routes may differ.

When the displayed destinations have been decided, the destination prediction unit 208 calculates the respective arrival times for routes to the destination and displays the arrival times on the display unit 212.

Note that when there are a large number of routes to a destination, it is possible for the destination prediction unit 208 to narrow down the routes to such destination to a specified number based on selection probabilities and to calculate only the arrival times for the displayed routes.

When there are a large number of routes to the destination, aside from deciding the displayed routes in descending order of the probability of the routes being selected, it is also possible to decide the displayed routes in order starting with the shortest arrival time and/or in order starting with the shortest distance to the destination. If the order starting with the shortest arrival time is decided as the display order, it is possible for example for the destination prediction unit 208 to first calculate the arrival times for all of the routes to the destination and then decide the displayed routes based on the calculated arrival times. Alternatively, if the order starting with the shortest distance to the destination is decided as the display order, it is possible for example for the destination prediction unit 208 to first calculate the distances to the destination based on information on the latitude and longitude corresponding to the state nodes for all of the routes to the destination and then decide the displayed routes based on the calculated distances.

The operation unit 210 receives information inputted by the user and supplies the information to the destination prediction unit 208. The display unit 212 displays information supplied from the behavior learning unit 304 or the destination prediction unit 208.

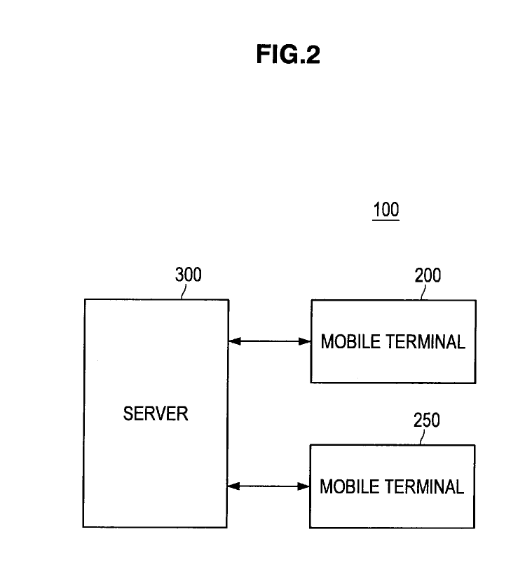

As one example, the behavior prediction system 100 configured as described above is capable of using the hardware configuration shown in FIG. 2. That is, FIG. 2 is a block diagram showing one example of a hardware configuration of the behavior prediction system 100.

In FIG. 2, the behavior prediction system 100 includes the two mobile terminals 200, 250 and the server 300. However, the behavior prediction system 100 may alternatively include just the mobile terminal 200 and the server 300. That is, although the behavior prediction system 100 illustrated in FIG. 2 includes the two mobile terminals 200 and 250 and the server 300, the behavior prediction system 100 may include one mobile terminal 200 and the server 300 or two mobile terminals 200 and 250 and the server 300. The two mobile terminals 200 and 250 may be mobile terminals with the same functions or as described later may be mobile terminals with different functions. Also, one of the mobile terminals 200 and 250 may be a fixed terminal.

The mobile terminals 200 and 250 are capable of transferring data to and from the server 300 by communication via wireless communication and/or a network such as the Internet. The server 300 receives data that has been transmitted from the mobile terminals 200, 250 and carries out a specified process on the received data. The server 300 then transmits the processing result of such data processing to the mobile terminals 200, 250 by mobile communication or the like.

Accordingly, the mobile terminals 200 and 250 and the server 300 may include at least a communication unit that carries out wired or wireless communication.

In addition, a configuration may be used where the mobile terminal 200 includes the positioning unit 202, the behavior recognition unit 204, the behavior prediction unit 206, the destination prediction unit 208, the operation unit 210, and the display unit 212 shown in FIG. 1 and the server 300 includes the time-series log storage unit 302 and the behavior learning unit 304 shown in FIG. 1.

When such configuration is used, in the learning process, the mobile terminal 200 transmits the time-series log which includes the positioning information obtained by the positioning unit 202 and the operation information for operations made by the user and the wireless communication state information. The mobile terminal 200 may also temporarily store the time-series log described above in a storage unit (not shown) in the mobile terminal 200 before transmission to the server 300. Based on the received time-series log for learning purposes, the server 300 learns the activity state of the user by way of the stochastic state transition model and transmits parameters obtained by the learning to the mobile terminal 200. After this, in the prediction process, using the positioning information acquired in real time by the positioning unit 202 and the parameters received from the server 300, the mobile terminal 200 recognizes the present location of the user and also calculates the route(s) and time(s) to the destination(s). The mobile terminal 200 then displays the route(s) and time(s) to the destination(s) as the calculation result on the display unit 212.

The assigning of processing to the mobile terminal 200 and the server 300 described above may be decided in accordance with the processing ability of the respective devices as information processing apparatuses and the communication environment.

Although the processing carried out in each iteration of the learning process is extremely time consuming, such processing does not need to be carried out very frequently. Accordingly, it is possible to have the server 300 carry out the learning process (i.e., the updating of parameters) based on a time-series log that is accumulated once a day or so. The server 300 may have a function that repairs the accumulated log before the learning process is carried out. In this case, it is possible to put accumulated log entries into the correct order and to delete duplicated log entries that have been accumulated.

Meanwhile, for the prediction process, since it is preferable for processing and displaying to be carried out at high speed in response to the positioning information that is updated instantly in real time, processing is carried out at the mobile terminal 200.

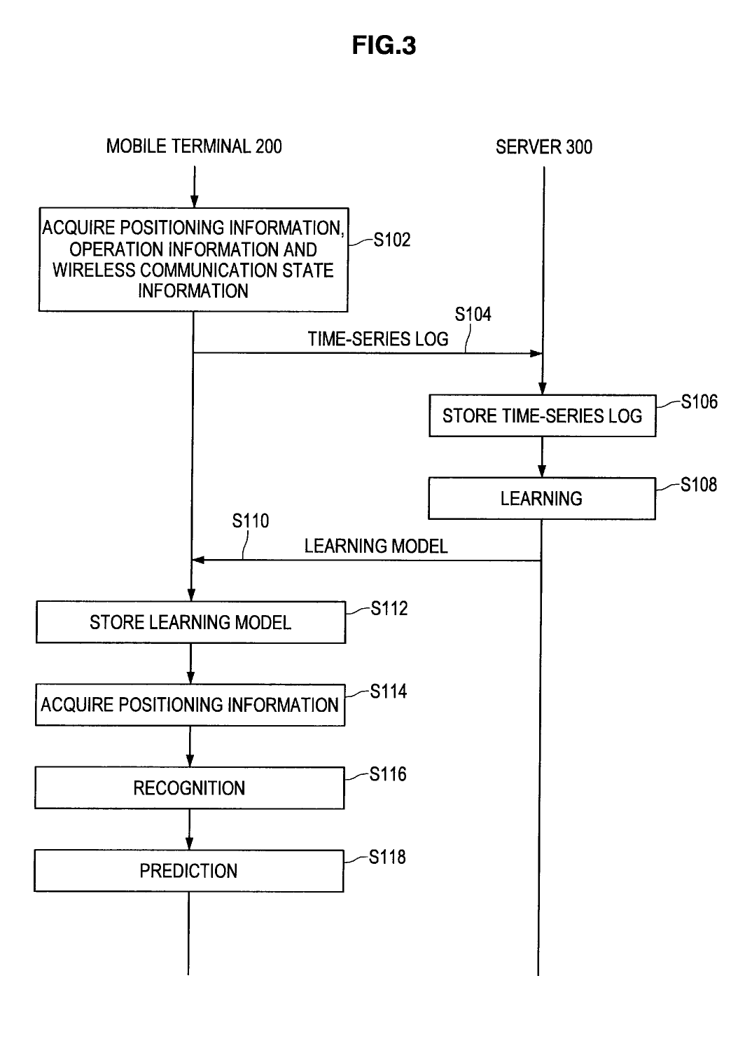

Next, the behavior prediction process executed by the behavior prediction system 100 in FIG. 1 will be described. FIG. 3 is a sequence chart of the behavior prediction process executed by the behavior prediction system 100 in FIG. 1.

In FIG. 3, first the mobile terminal 200 acquires positioning information from the positioning unit 202, operation information received from the user via the operation unit 210, and the wireless communication state information for wireless communication between the mobile terminal 200 and the server 300 (step S102).

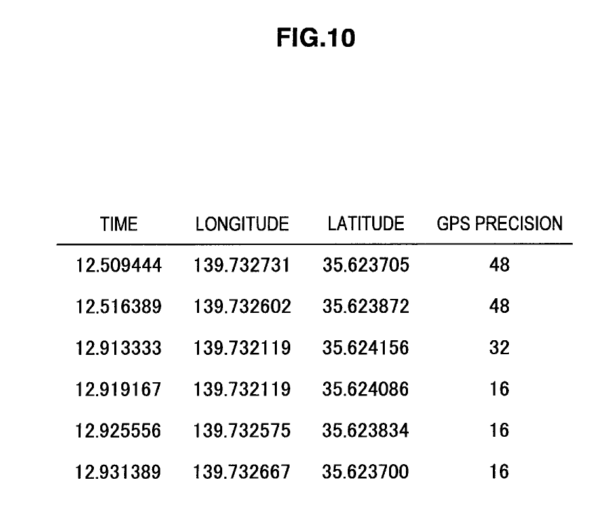

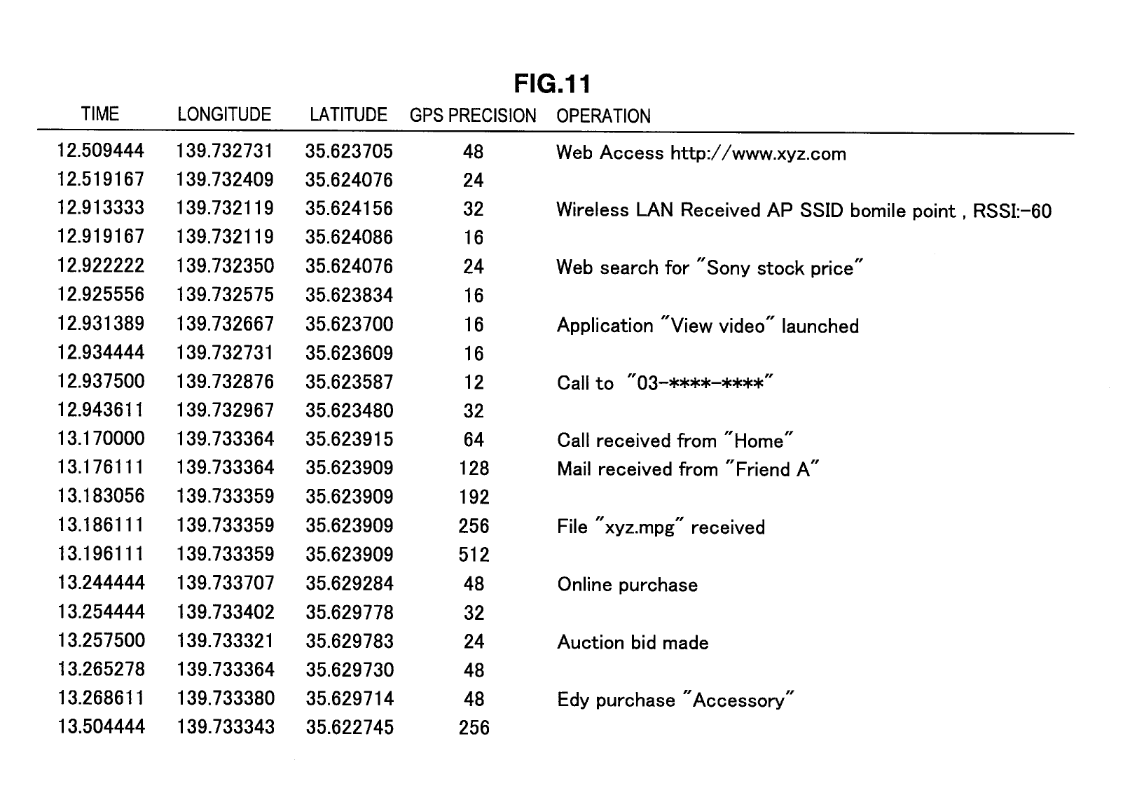

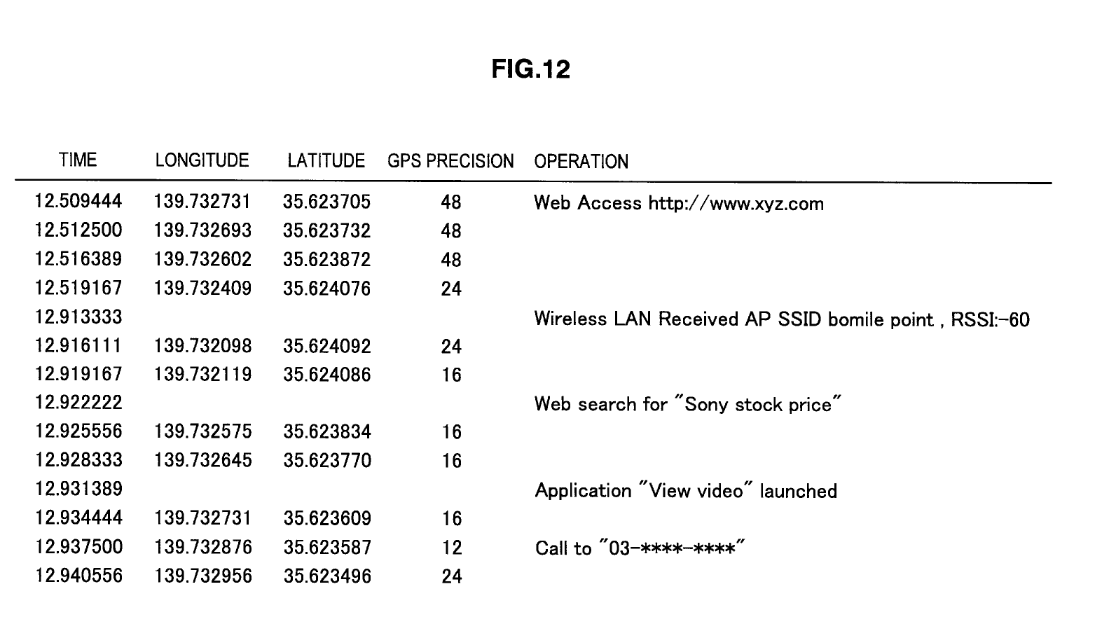

After this, the mobile terminal 200 transmits a log entry that includes the positioning information, the operation information, and the wireless communication state information acquired in step S102, or a time-series log in which such log entries have been accumulated for a certain period in a time series, to the server 300 (step S104). FIG. 10 is a diagram useful in explaining one example of a time-series log, where a log entry includes time information, longitude information, latitude information, and GPS precision information. FIG. 11 is a diagram useful in explaining another example of a time-series log, where a log entry includes time information, longitude information, latitude information, GPS precision information, and operation information. FIG. 12 is a diagram useful in explaining yet another example of a time-series log, where there are cases where a log entry includes time information, longitude information, latitude information, GPS precision information, and operation information and cases where a log entry includes time information and operation information. When a log entry includes time information and operation information, it is possible to fill in the longitude information and the latitude information by carrying out an interpolation process using the previous and next log entries.

Next, the time-series log storage unit 302 of the server 300 stores the log entry or the time-series log transmitted from the mobile terminal 200 in step S104 (step S106).

After this, the behavior learning unit 304 of the server 300 learns, as the stochastic state transition model, the activity state of the user carrying the mobile terminal 200 in which the positioning unit 202 is incorporated based on the time-series log stored in the time-series log storage unit 302 (step S108).

Next, the behavior learning unit 304 of the server 300 transmits the parameters of the stochastic state transition model obtained by the learning process to the mobile terminal 200 (step S110).

After this, the mobile terminal 200 stores the stochastic state transition model of the parameters received in step S110 (step S112).

Next, the behavior recognition unit 204 of the mobile terminal 200 acquires the positioning information from the positioning unit 202 (step S114).

After this, the behavior recognition unit 204 of the mobile terminal 200 uses the stochastic state transition model of the parameters obtained by the learning to recognize the present activity state of the user, that is, the present location of the user, from the positioning information acquired from the positioning unit 202 (step S116). The behavior recognition unit 204 supplies the node number of the present state node of the user to the behavior prediction unit 206.

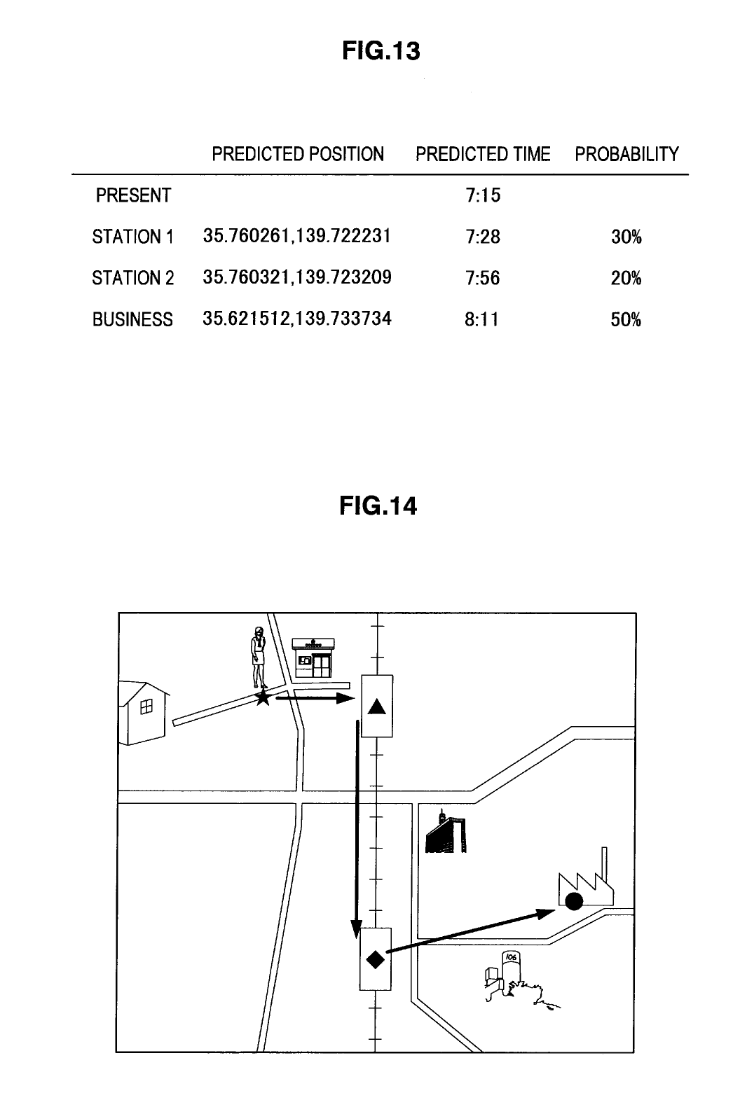

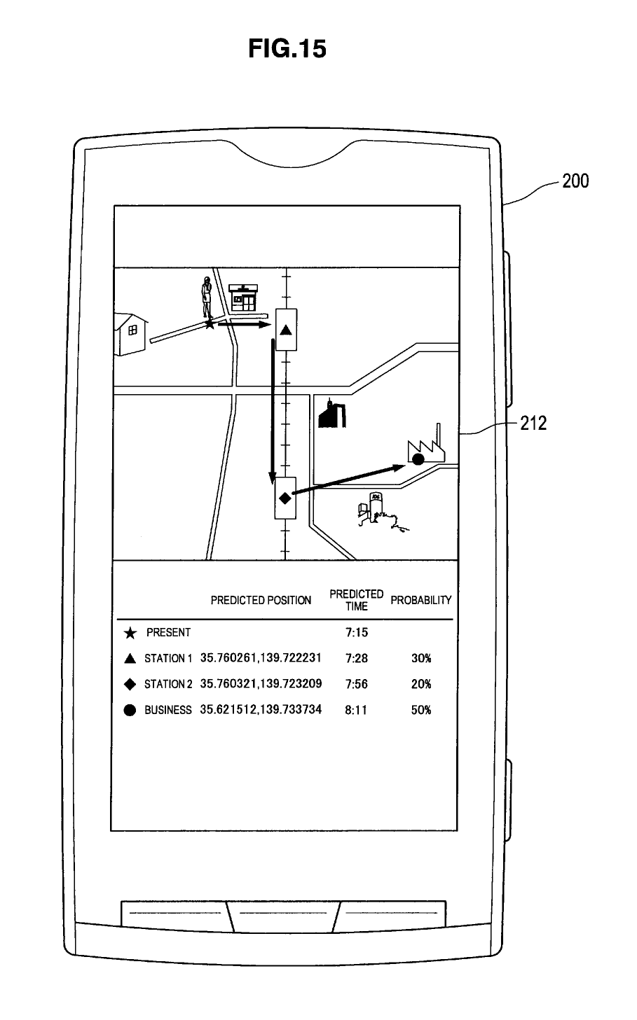

Next, the behavior prediction unit 206 of the mobile terminal 200 uses the stochastic state transition model of the parameters obtained by the learning to precisely search for (predict) routes that may be taken by the user from the present location of the user shown by the node number of the state node supplied from the behavior recognition unit 204 (step S118). Also, by calculating the occurrence probability for each of the found routes, the behavior prediction unit 206 predicts a selection probability that is the probability that each found route will be selected. The destination prediction unit 208 is then supplied from the behavior prediction unit 206 with the routes that can be taken by the user and the respective selection probabilities and uses the stochastic state transition model of the parameters obtained by the learning to predict destinations of the user. More specifically, the destination prediction unit 208 first lists destination candidates. The destination prediction unit 208 sets places where the recognized behavior state of the user becomes a visit state as destination candidates. After this, out of the listed destination candidates, the destination prediction unit 208 decides destination candidates on the routes found by the behavior prediction unit 206 as destinations. In addition, the destination prediction unit 208 calculates an arrival probability for each decided destination. When the destinations to be displayed have been decided, the destination prediction unit 208 then calculates the arrival times for routes to the destinations, displays such information on the display unit 212, and ends the present processing. FIG. 13 is a diagram useful in explaining one example of predicted position information, predicted time-of-arrival information, and arrival probability information for each destination predicted in step S118. FIG. 14 is a diagram useful in explaining one example of a screen displayed on the display unit 212. In FIG. 14, the star-shaped mark shows the present position in FIG. 13, the triangle-shaped mark shows the position of Station 1 in FIG. 13, the diamond-shaped mark shows the position of Station 2 in FIG. 13, and the circle-shaped mark shows the position of a business in FIG. 13. FIG. 15 is a diagram useful in explaining one example of a screen displayed on the display unit 212 of the mobile terminal 200.

According to the behavior prediction process in FIG. 3, since the mobile terminal 200 stores the parameters of the stochastic state transition model obtained by the learning process at the server 300 and carries out the prediction process using the stochastic state transition model for the stored parameters, compared to when the prediction process is carried out using all of the past movement history, it is possible to reduce the processing load of the mobile terminal 200. Also, by receiving the parameters of the stochastic state transition model from the server 300 when the wireless communication state is favorable and storing such parameters, it is possible for the mobile terminal 200 to carry out the prediction process even when the wireless communication state is poor.

Also, according to the present embodiment, the positioning unit 202 may transmit the latest time-series log to the server 300 when, based on the stochastic state transition model of the parameters that were previously received by the mobile terminal 200, wireless communication is possible between the mobile terminal 200 and the server 300. Similarly, the behavior recognition unit 204 and the behavior prediction unit 206 may receive parameters of the latest stochastic state transition model from the server 300 when, based on the stochastic state transition model of the parameters that were previously received by the mobile terminal 200, wireless communication is possible between the mobile terminal 200 and the server 300. In such cases, it is possible to carry out the prediction process, even when the wireless communication state is poor.

According to the present embodiment, as one example, the mobile terminal 200 predicts the behavior of the user, and when the wireless communication state at is poor at a place where the user is heading, or in other words, such place is an offline area, by carrying out transmission of the time-series log and/or reception of the stochastic state transition model before the user reaches such place, it is possible to carry out the same processing in an offline area as in an area where the wireless communication state is favorable, i.e., an online area.

### 2. Behavior Prediction System

### Second Embodiment

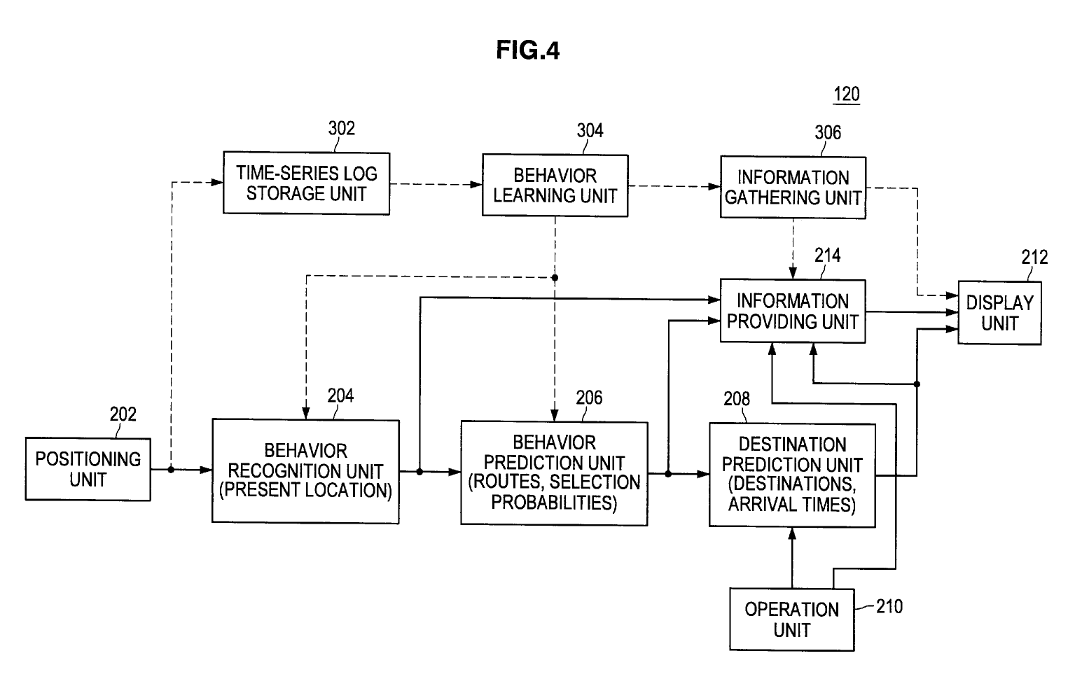

Next, a behavior prediction system according to a second embodiment of the present invention will be described. FIG. 4 is a block diagram showing the overall configuration of the behavior prediction system according to the present embodiment. Since the behavior prediction system according to the present embodiment differs to the first embodiment described earlier only by including an information providing unit 214 and an information gathering unit 306, description of duplicated structures and effects is omitted and the following description will instead focus on the different structures and effects.

As shown in FIG. 4, a behavior prediction system 120 includes the positioning unit 202, the time-series log storage unit 302, the behavior learning unit 304, the information gathering unit 306, the behavior recognition unit 204, the behavior prediction unit 206, the destination prediction unit 208, the operation unit 210, the display unit 212, and the information providing unit 214.

The information gathering unit 306 uses the stochastic state transition model of the parameters obtained by learning by the behavior learning unit 304 to gather information desired by the user based on the activity state of the user via the Internet or the like. For example, the information gathering unit 306 gathers information on shops based on information on the longitude and latitude of the movement path of the user in the activity state of the user and information on the longitudes and latitudes of shops, for example. The information gathering unit 306 then transmits the gathered information desired by the user to the information providing unit 214.

Note that timetable information or train service information for a station on the movement path and store sale information or store coupon information for stores on the movement path can be given as examples of information desired by the user.

The information providing unit 214 is one example of an “information reception unit” and an “information deciding unit” according to the present invention, stores information desired by the user that has been transmitted from the information gathering unit 306, decides the information to be provided to the user based on information on the present location of the user recognized by the behavior recognition unit 204 and the output information of the behavior prediction unit 206 and the destination prediction unit 208, and has the decided information displayed on the display unit 212. That is, the information providing unit 214 carries out behavior recognition based on the present location of the user and provides the result of subsequent behavior prediction/destination prediction, that is, information relating to locations en route to destinations or the destinations themselves. The information providing unit 214 may be supplied from the operation unit 210 with information from the user that shows what information is desired.

2-1. Behavior Prediction System Including One Mobile Terminal and One Server

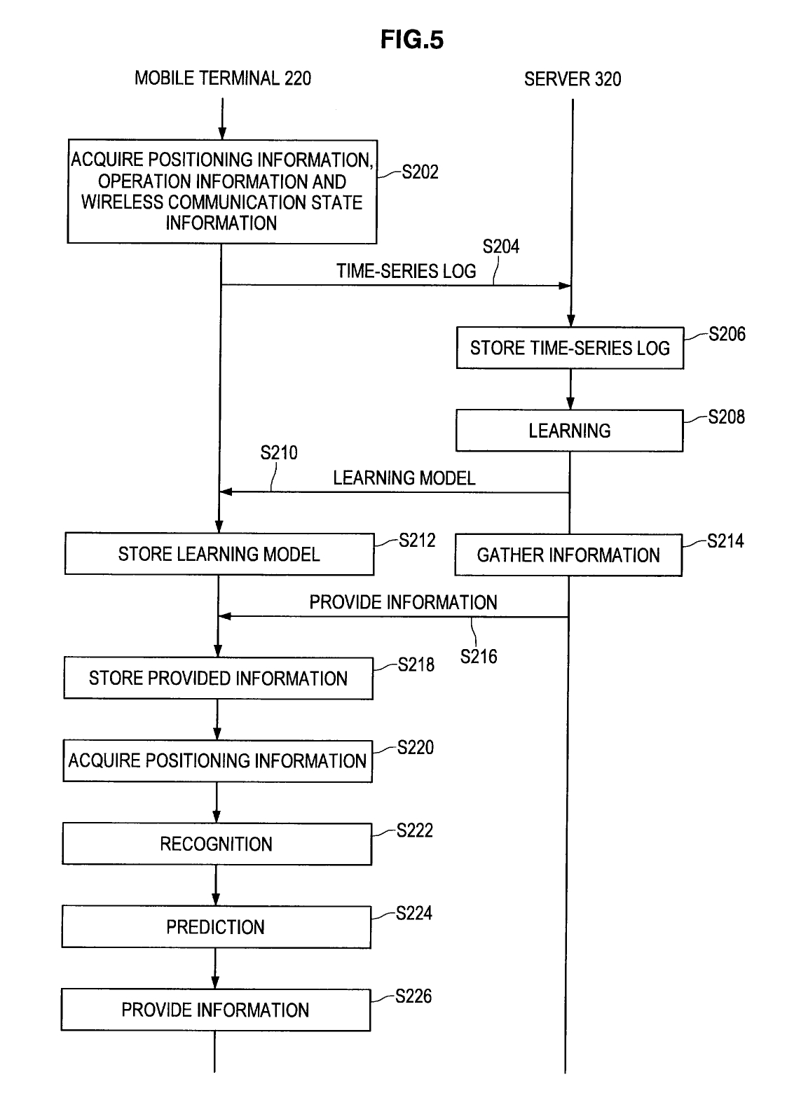

Next, a behavior prediction process executed by the behavior prediction system 120 in FIG. 4 will be described for a case where the behavior prediction system 120 includes one mobile terminal and one server. FIG. 5 is a sequence chart of the behavior prediction process executed by the behavior prediction system 120 in FIG. 4 for the case where the behavior prediction system 120 includes one mobile terminal and one server.

In FIG. 5, first, a mobile terminal 220 acquires positioning information from the positioning unit 202, operation information received from the user via the operation unit 210, and wireless communication state information for wireless communication between the mobile terminal 220 and the server 320 (step S202).

After this, the mobile terminal 220 transmits a log entry that includes the positioning information, the operation information, and the wireless communication state information acquired in step S202 or a time-series log in which such log entries have been accumulated for a certain period in a time series to the server 320 (step S204).

Next, the time-series log storage unit 302 of the server 320 stores the log entry or the time-series log transmitted from the mobile terminal 220 in step S204 (step S206).

After this, the behavior learning unit 304 of the server 320 learns, as the stochastic state transition model, the activity state of the user carrying the mobile terminal 220 in which the positioning unit 202 is incorporated based on the time-series log stored in the time-series log storage unit 302 (step S208).

Next, the behavior learning unit 304 of the server 320 transmits the parameters of the stochastic state transition model obtained by the learning process to the mobile terminal 220 (step S210).

After this, the mobile terminal 220 stores the stochastic state transition model of the parameters received in step S210 (step S212).

Meanwhile, the server 320 uses the stochastic state transition model of the parameters obtained by the learning process to gather information desired by the user based on the activity state of the user via the Internet or the like (step S214).

Next, the server 320 transmits the information desired by the user gathered in step S214 to the mobile terminal 220 (step S216).

After this, the mobile terminal 220 stores the information desired by the user received in step S216 (step S218).

Next, the behavior recognition unit 204 of the mobile terminal 220 acquires the positioning information from the positioning unit 202 (step S220).

After this, the behavior recognition unit 204 of the mobile terminal 220 uses the stochastic state transition model of the parameters obtained by the learning to recognize the present activity state of the user, that is, the present location of the user, from the positioning information acquired from the positioning unit 202 (step S222). The behavior recognition unit 204 supplies the node number of the present state node of the user to the behavior prediction unit 206.

Next, the behavior prediction unit 206 of the mobile terminal 220 uses the stochastic state transition model of the parameters obtained by the learning to precisely search for (predict) routes that may be taken by the user from the present location of the user shown by the node number of the state node supplied from the behavior recognition unit 204 (step S224). Also, by calculating the occurrence probability for each of the found routes, the behavior prediction unit 206 predicts a selection probability that is the probability that each found route will be selected. The destination prediction unit 208 is then supplied from the behavior prediction unit 206 with the routes that can be taken by the user and the respective selection probabilities and uses the stochastic state transition model of the parameters obtained by the learning to predict destinations of the user. More specifically, the destination prediction unit 208 first lists destination candidates. The destination prediction unit 208 sets places where the recognized behavior state of the user becomes a visit state as destination candidates. After this, out of the listed destination candidates, the destination prediction unit 208 decides destination candidates on the routes found by the behavior prediction unit 206 as destinations. In addition, the destination prediction unit 208 calculates an arrival probability for each decided destination. When the destinations to be displayed have been decided, the destination prediction unit 208 then calculates the arrival times for routes to the destinations and displays such information on the display unit 212.

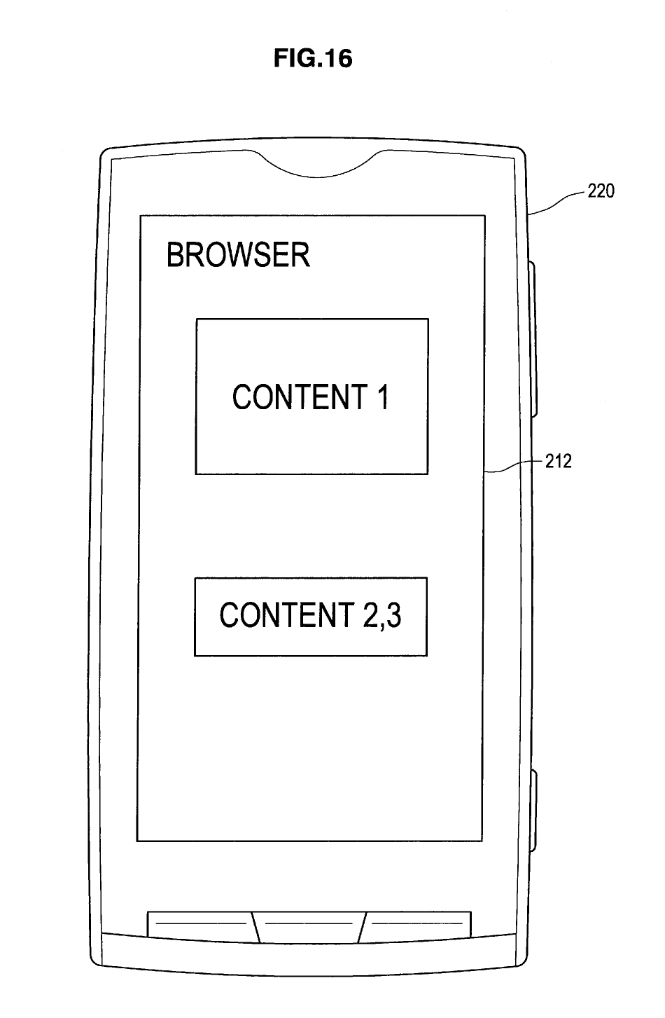

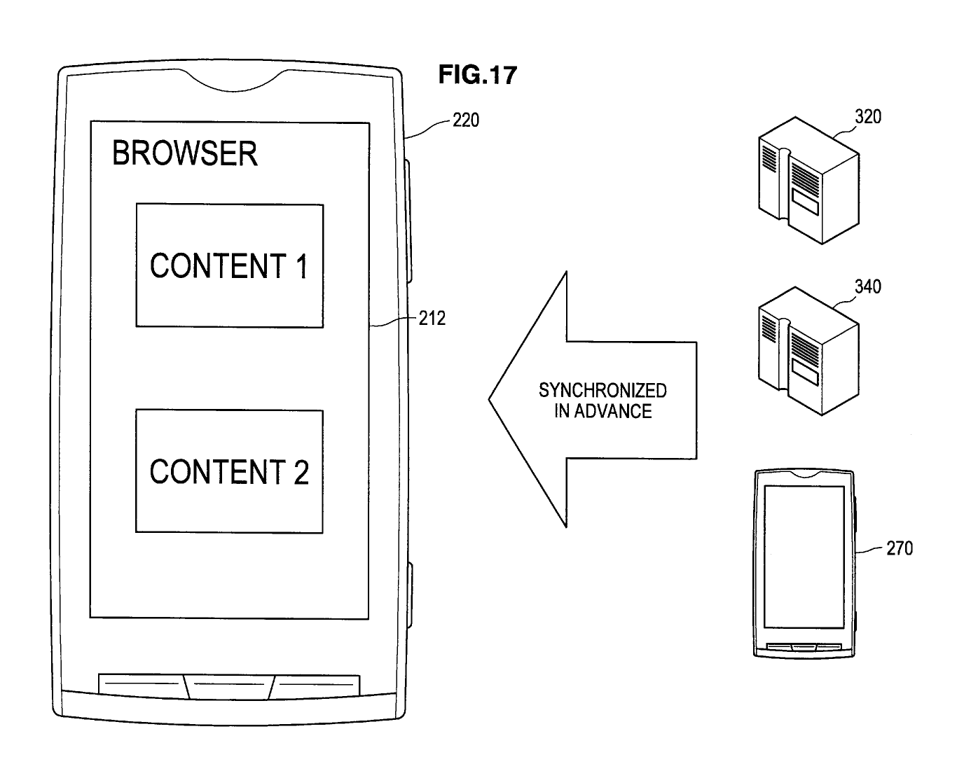

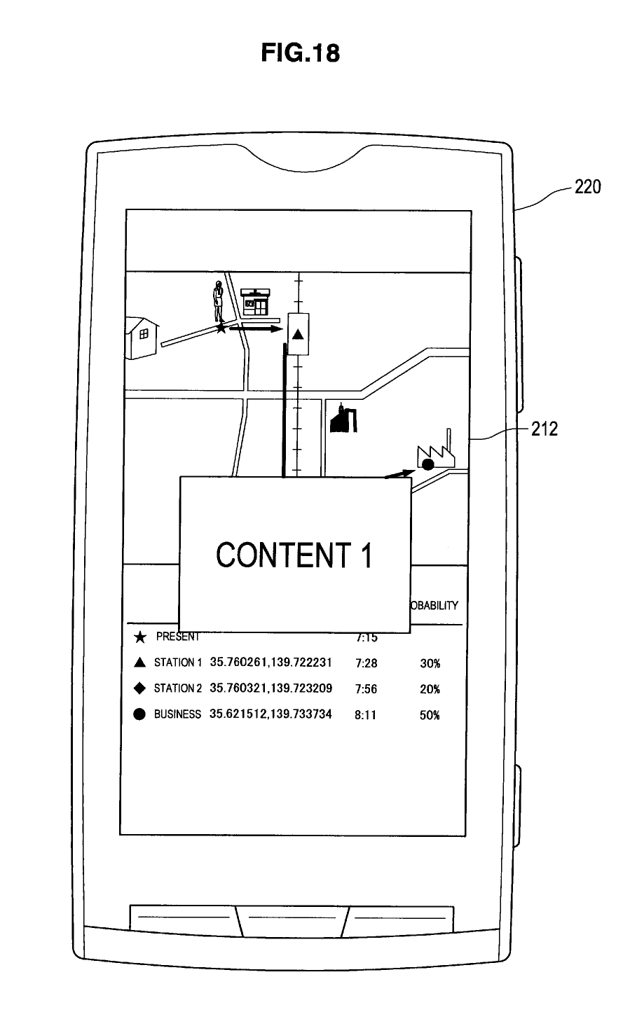

Next, the information providing unit 214 of the mobile terminal 220 decides the information to be provided to the user out of the information desired by the user stored in step S218 based on the information on the present location of the user recognized in step S222, displays the decided information on the display unit 212 (step S226), and ends the present process. FIG. 16 is a diagram useful in explaining one example of the displaying of information provided to the user via display on the display unit 212 in the mobile terminal 220. In FIG. 16, content 1 is information with a high probability of being desired by the user, with it being possible to immediately launch the content when the user taps a region of the content 1 on the display unit 212. Note that information such as content 1 that has a high probability of being desired by the user may be automatically launched when a certain condition is satisfied. Also, in FIG. 16, content 2, 3 is information with a lower probability of being desired by the user than content 1, with it being possible to display a list of content when the user taps a region of content 2, 3 on the display unit 212. Also, as shown in FIG. 17, content 1 and content 2 displayed on the display unit 212 of the mobile terminal 220 may be set in advance so as to be synchronized with content of the server 320 on the Internet, user content on a server 340, or content of another mobile terminal 270. As shown in FIG. 18, on the display unit 212 of the mobile terminal 220, the content 1 may be displayed on top of the result screen of the prediction process.

According to the behavior prediction process in FIG. 5, since the mobile terminal 220 stores the parameters of the stochastic state transition model obtained by the learning process at the server 320 and carries out the prediction process using the stochastic state transition model for the stored parameters, compared to when the prediction process is carried out using all of the past movement history, it is possible to reduce the processing load of the mobile terminal 220. Also, by receiving the parameters for the stochastic state transition model from the server 320 when the wireless communication state is favorable and storing such parameters, it is possible for the mobile terminal 220 to carry out the prediction process even when the wireless communication state is poor. Also, since the server 320 gathers information desired by the user and transmits the gathered information desired by the user to the mobile terminal 220 and the mobile terminal 220 decides the information to be provided to the user out of the information desired by the user that has been received from the server 320, it is possible to make it unnecessary for the mobile terminal 220 to gather the information desired by the user, which makes it possible to further reduce the processing load of the mobile terminal 220.

Also, according to the present embodiment, the mobile terminal 220 may receive the latest information desired by the user when, based on the stochastic state transition model of the parameters that were previously received by the mobile terminal 200, wireless communication is possible between the mobile terminal 200 and the server 300. In such case, it is possible to provide the latest information desired by the user, even when the wireless communication state is poor.

Also, in the present embodiment, although the server 320 is described above as gathering the information desired by the user via the Internet or the like, the server 320 may transmit only URL information showing a location on the Internet of the information desired by the user to the mobile terminal 220 to enable the mobile terminal 220 to acquire the latest information desired by the user via the Internet or the like based on the URL information. That is, only URL information may be stored in the information providing unit 214 and the mobile terminal 220 may download the latest content using the URL information when behavior prediction is carried out and information is provided. The information providing unit 214 may also automatically acquire information (flight/train information, news, or the like) from the Internet from a site where the URL information remains the same but the content is updated to the latest content. Alternatively, the information providing unit 214 may acquire information from the Internet according to a user operation of the operation unit 210. In addition, a communication schedule for an optimal time/location for downloading may be set.

According to the present embodiment, as one example, the mobile terminal 200 predicts the behavior of the user, and when the wireless communication state is poor at the place where the user is heading, or in other words, such place is an offline area, by carrying out transmission of the time-series log and/or reception of the stochastic state transition model and reception of the information desired by the user before the user reaches such place, it is possible to carry out the same processing in an offline area as in an area where the wireless communication state is favorable, i.e., an online area.

2-2. Behavior Prediction System Including Two Mobile Terminals and One Server

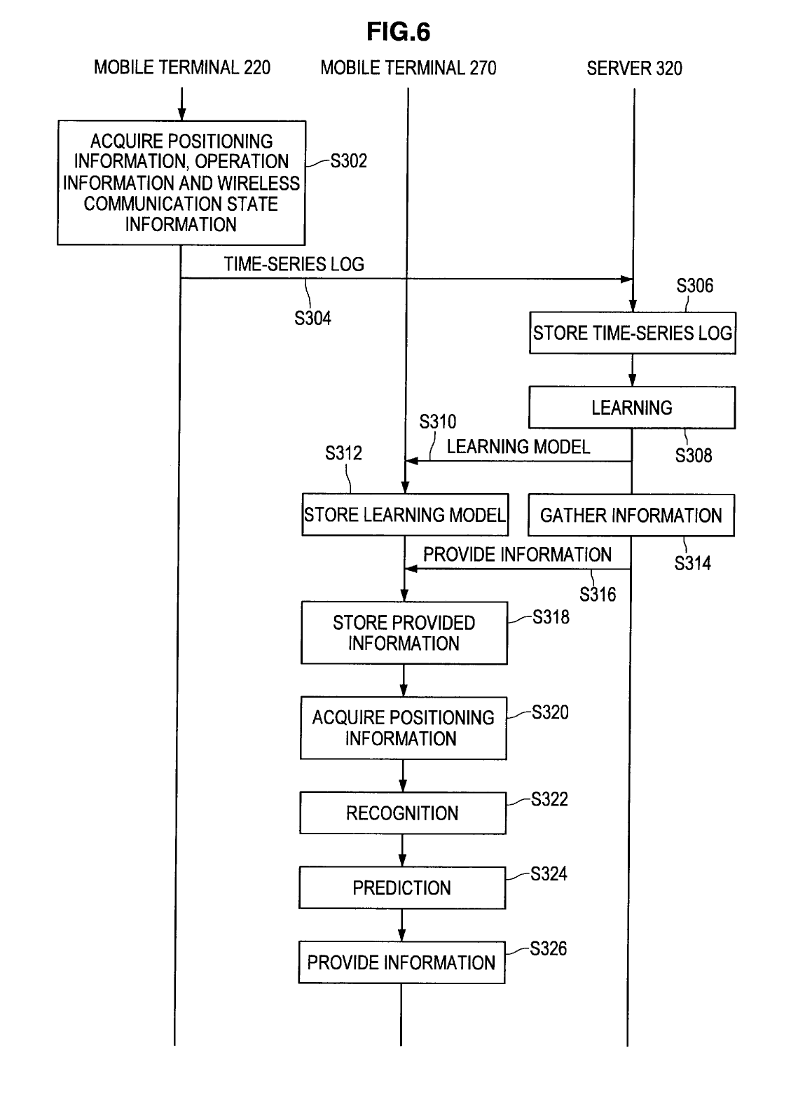

Next, a behavior prediction process executed by the behavior prediction system 120 in FIG. 4 will be described for a case where the behavior prediction system 120 includes two mobile terminals and one server. FIG. 6 is a sequence chart of the behavior prediction process executed by the behavior prediction system 120 in FIG. 4 for the case where the behavior prediction system 120 is constructed of two mobile terminals and one server. The present embodiment is processing carried out when the positioning precision of the mobile terminal 220 is higher than that of the mobile terminal 270, for example. Such processing is also carried out when the mobile terminal 270 has an information providing function. Also, a positioning function may be omitted from the mobile terminal 270 which acquires positioning information from the mobile terminal 220, for example, and carries out the prediction process and the like.

In FIG. 6, first, the mobile terminal 220 acquires positioning information from the positioning unit 202, operation information received from the user via the operation unit 210, and the wireless communication state information for wireless communication between the mobile terminal 220 and the server 300 (step S302).

After this, the mobile terminal 220 transmits a log entry that includes the positioning information, the operation information, and the wireless communication state information acquired in step S302 or a time-series log in which such log entries have been accumulated for a certain period in a time series to the server 320 (step S304).

Next, the time-series log storage unit 302 of the server 300 stores the log transmitted from the mobile terminal 220 in step S304 or the time-series log(step S306).

After this, the behavior learning unit 304 of the server 320 learns, as the stochastic state transition model, the activity state of the user carrying the mobile terminal 220 in which the positioning unit 202 is incorporated based on the time-series log stored in the time-series log storage unit 302 (step S308).

Next, the behavior learning unit 304 of the server 320 transmits the parameters of the stochastic state transition model obtained by the learning process to the mobile terminal 270 (step S310).

After this, the mobile terminal 270 stores the stochastic state transition model of the parameters received in step S310 (step S312).

Meanwhile, the server 320 uses the stochastic state transition model of the parameters obtained by the learning process to gather information desired by the user based on the activity state of the user from the Internet or the like (step S314).

After this, the server 320 transmits the information desired by the user gathered in step S314 to the mobile terminal 270 (step S316).

Next, the mobile terminal 270 stores the information desired by the user received in step S316 (step S318).

After this, the behavior recognition unit 204 of the mobile terminal 270 acquires the positioning information from the positioning unit 202 (step S320).

Next, the behavior recognition unit 204 of the mobile terminal 270 uses the stochastic state transition model obtained by the learning to recognize the present activity state of the user, that is, the present location of the user, from the positioning information acquired from the positioning unit 202 (step S322). The behavior recognition unit 204 supplies the node number of the present state node of the user to the behavior prediction unit 206.

After this, the behavior prediction unit 206 of the mobile terminal 270 uses the stochastic state transition model of the parameters obtained by the learning to precisely search for (predict) routes that may be taken by the user from the present location of the user shown by the node number of the state node supplied from the behavior recognition unit 204 (step S324). Also, by calculating the occurrence probability for each of the found routes, the behavior prediction unit 206 predicts a selection probability that is the probability that each found route will be selected. The destination prediction unit 208 is then supplied from the behavior prediction unit 206 with the routes that can be taken by the user and the respective selection probabilities and uses the stochastic state transition model of the parameters obtained by the learning to predict destinations of the user. More specifically, the destination prediction unit 208 first lists destination candidates. The destination prediction unit 208 sets places where the recognized behavior state of the user becomes a visit state as destination candidates. After this, out of the listed destination candidates, the destination prediction unit 208 decides destination candidates on the routes found by the behavior prediction unit 206 as destinations. In addition, the destination prediction unit 208 calculates an arrival probability for each decided destination. When the destinations to be displayed have been decided, the destination prediction unit 208 then calculates the arrival times for routes to the destinations and displays such information on the display unit 212.

After this, the information providing unit 214 of the mobile terminal 270 decides the information to be provided to the user out of the information desired by the user stored in step S318 based on the information on the present location of the user recognized in step S322, displays the decided information on the display unit 212 (step S326), and ends the present process.

According to the behavior prediction process in FIG. 6, since the mobile terminal 270 stores the parameters of the stochastic state transition model obtained by the learning process at the server 320 and carries out the prediction process using the stochastic state transition model for the stored parameters, compared to when the prediction process is carried out using all of the past movement history, it is possible to reduce the processing load of the mobile terminal 270. Also, by receiving the parameters of the stochastic state transition model from the server 320 when the wireless communication state is favorable and storing the parameters, it is possible for the mobile terminal 270 to carry out the prediction process even when the wireless communication state is poor. Also, since the server 320 gathers information desired by the user and transmits the gathered information desired by the user to the mobile terminal 270 and the mobile terminal 270 decides the information to be provided to the user out of the information desired by the user that has been received from the server 320, it is possible to make it unnecessary for the mobile terminal 270 to gather the information desired by the user, which makes it possible to further reduce the processing load of the mobile terminal 270.

Also, according to the present embodiment, the mobile terminal 270 receives an activity model expressing the activity state of the user obtained by the learning process by the server 320 based on the time-series log including positioning information acquired by the positioning unit 202 of another mobile terminal 220. If the positioning precision of the mobile terminal 220 is high compared to the mobile terminal 270, when it is desirable to provide information at the mobile terminal 270, it is possible to improve the precision of the prediction process by using position information of the mobile terminal 220 that has high positioning precision.

### 3. Behavior Prediction System

### Third Embodiment

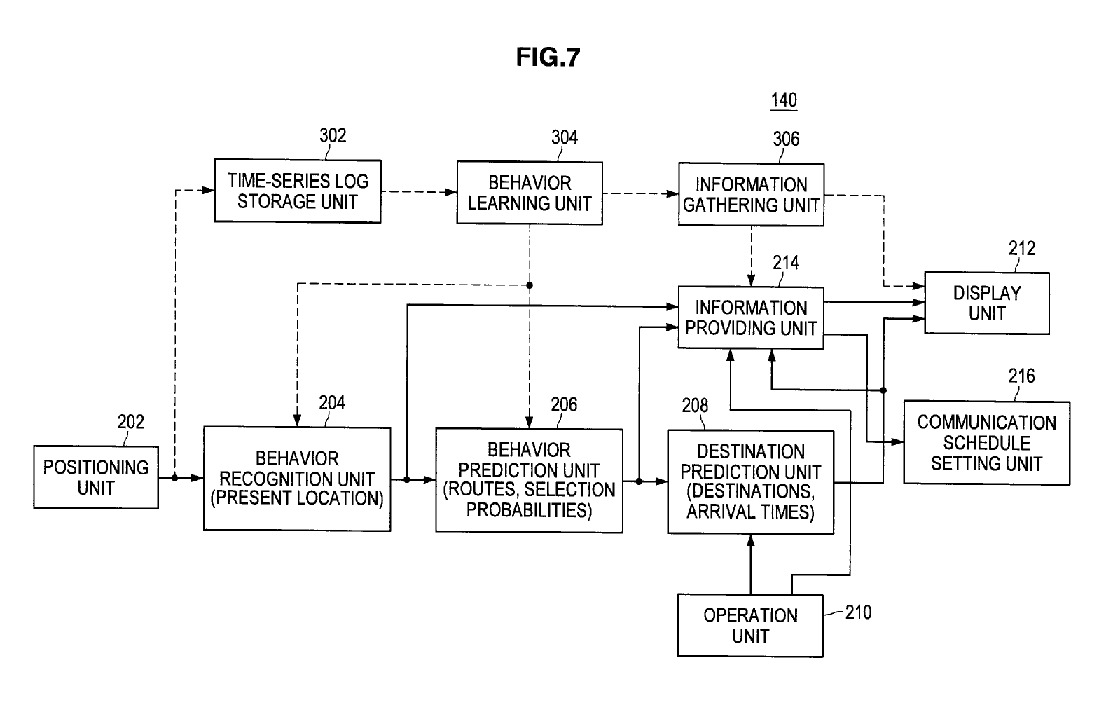

Next, a behavior prediction system according to a third embodiment of the present invention will be described. FIG. 7 is a block diagram showing the overall configuration of the behavior prediction system according to the present embodiment. Since the behavior prediction system according to the present embodiment differs to the second embodiment described earlier only by including a communication schedule setting unit 216, description of duplicated structures and effects is omitted and the following description will instead focus on the different structures and effects.

As shown in FIG. 7, a behavior prediction system 140 includes the positioning unit 202, the time-series log storage unit 302, the behavior learning unit 304, the information gathering unit 306, the behavior recognition unit 204, the behavior prediction unit 206, the destination prediction unit 208, the operation unit 210, the display unit 212, the information providing unit 214, and the communication schedule setting unit 216.

The communication schedule setting unit 216 is one example of a “setting unit” for the present invention and uses the stochastic state transition model for the parameters obtained by the learning to make settings so that information, which is desired by the user and is likely to be acquired by a user operation on a route that may be taken by the user from the present location of the user shown by a node number of a state node supplied from the behavior recognizing unit 204, is acquired on the route at a location where the state of the wireless network is favorable.

3-1. Behavior Prediction System Including One Mobile Terminal and One Server

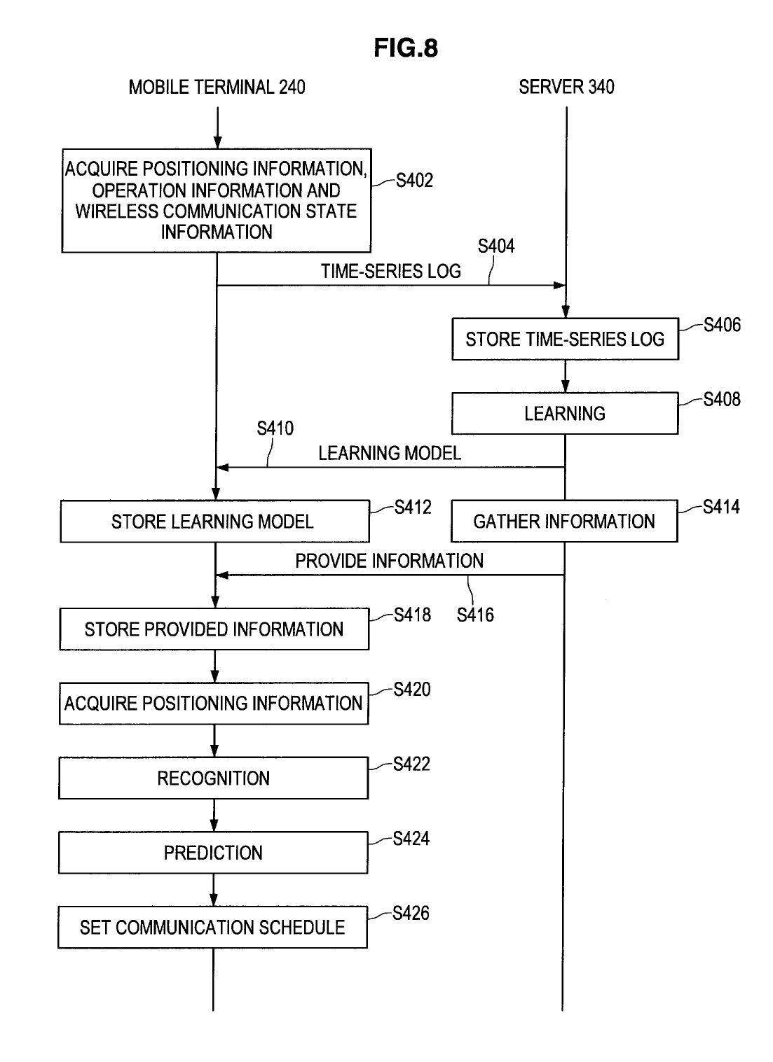

Next, a behavior prediction process executed by the behavior prediction system 140 in FIG. 7 will be described for a case where the behavior prediction system 140 includes one mobile terminal and one server. FIG. 8 is a sequence chart of the behavior prediction process executed by the behavior prediction system 140 in FIG. 7 for the case where the behavior prediction system 140 includes one mobile terminal and one server.

In FIG. 8, first, a mobile terminal 240 acquires positioning information from the positioning unit 202, operation information received from the user via the operation unit 210, and wireless communication state information for wireless communication between the mobile terminal 240 and the server 340 (step S402).

After this, the mobile terminal 240 transmits a log entry that includes the positioning information, the operation information, and the wireless communication state information acquired in step S402 or a time-series log in which such log entries have been accumulated for a certain period in a time series to the server 340 (step S404).

Next, the time-series log storage unit 302 of the server 340 stores the log entry or the time-series log transmitted from the mobile terminal 240 in step S404 (step S406).

After this, the behavior learning unit 304 of the server 340 learns, as the stochastic state transition model, the activity state of the user carrying the mobile terminal 240 in which the positioning unit 202 is incorporated based on the time-series log stored in the time-series log storage unit 302 (step S408).

Next, the behavior learning unit 304 of the server 340 transmits the parameters of the stochastic state transition model obtained by the learning process to the mobile terminal 220 (step S410).

After this, the mobile terminal 240 stores the stochastic state transition model of the parameters received in step S410 (step S412).

Meanwhile, the server 340 uses the stochastic state transition model of the parameters obtained by the learning process to gather information desired by the user based on the activity state of the user via the Internet or the like (step S414).

Next, the server 340 transmits the information desired by the user gathered in step S214 to the mobile terminal 240 (step S416).

After this, the mobile terminal 240 stores the information desired by the user received in step S416 (step S418).

Next, the behavior recognition unit 204 of the mobile terminal 240 acquires the positioning information from the positioning unit 202 (step S420).

After this, the behavior recognition unit 204 of the mobile terminal 240 uses the stochastic state transition model of the parameters obtained by the learning to recognize the present activity state of the user, that is, the present location of the user, from the positioning information acquired from the positioning unit 202 (step S422). The behavior recognition unit 204 supplies the node number of the present state node of the user to the behavior prediction unit 206.

Next, the behavior prediction unit 206 of the mobile terminal 240 uses the stochastic state transition model of the parameters obtained by the learning to precisely search for (predict) routes that may be taken by the user from the present location of the user shown by the node number of the state node supplied from the behavior recognition unit 204 (step S424). Also, by calculating the occurrence probability for each of the found routes, the behavior prediction unit 206 predicts a selection probability that is the probability that each found route will be selected. The destination prediction unit 208 is then supplied from the behavior prediction unit 206 with the routes that can be taken by the user and the respective selection probabilities and uses the stochastic state transition model of the parameters obtained by the learning to predict destinations of the user. More specifically, the destination prediction unit 208 first lists destination candidates. The destination prediction unit 208 sets places where the recognized behavior state of the user becomes a visit state as destination candidates. After this, out of the listed destination candidates, the destination prediction unit 208 decides destination candidates on the routes found by the behavior prediction unit 206 as destinations. In addition, the destination prediction unit 208 calculates an arrival probability for each decided destination. When the destinations to be displayed have been decided, the destination prediction unit 208 then calculates the arrival times for routes to the destinations and displays such information on the display unit 212.

Next, the communication schedule setting unit 216 of the mobile terminal 240 sets a communication schedule based on the information on the present location of the user recognized in step S422 so as to acquire information, which is desired by the user and is likely to be acquired by a user operation on a route that may be taken by the user, at a location on the route where the state of the wireless network is favorable (step S426), and ends the present process.

According to the behavior prediction process in FIG. 8, since the mobile terminal 240 stores the parameters of the stochastic state transition model obtained by the learning process at the server 340 and carries out the prediction process using the stochastic state transition model for the stored parameters, compared to when the prediction process is carried out using all of the past movement history, it is possible to reduce the processing load of the mobile terminal 240. Also, by receiving the parameters for the stochastic state transition model from the server 340 when the wireless communication state is favorable and storing such parameters, it is possible for the mobile terminal 240 to carry out the prediction process even when the wireless communication state is poor. In addition, by setting a communication schedule so as to acquire information, which is desired by the user and is likely to be acquired by a user operation on a route that may be taken by the user, at a location on the route where the state of the wireless network is favorable, it becomes possible to provide information to the user even when the wireless communication state is poor.

3-2. Behavior Prediction System Including Two Mobile Terminals and One Server

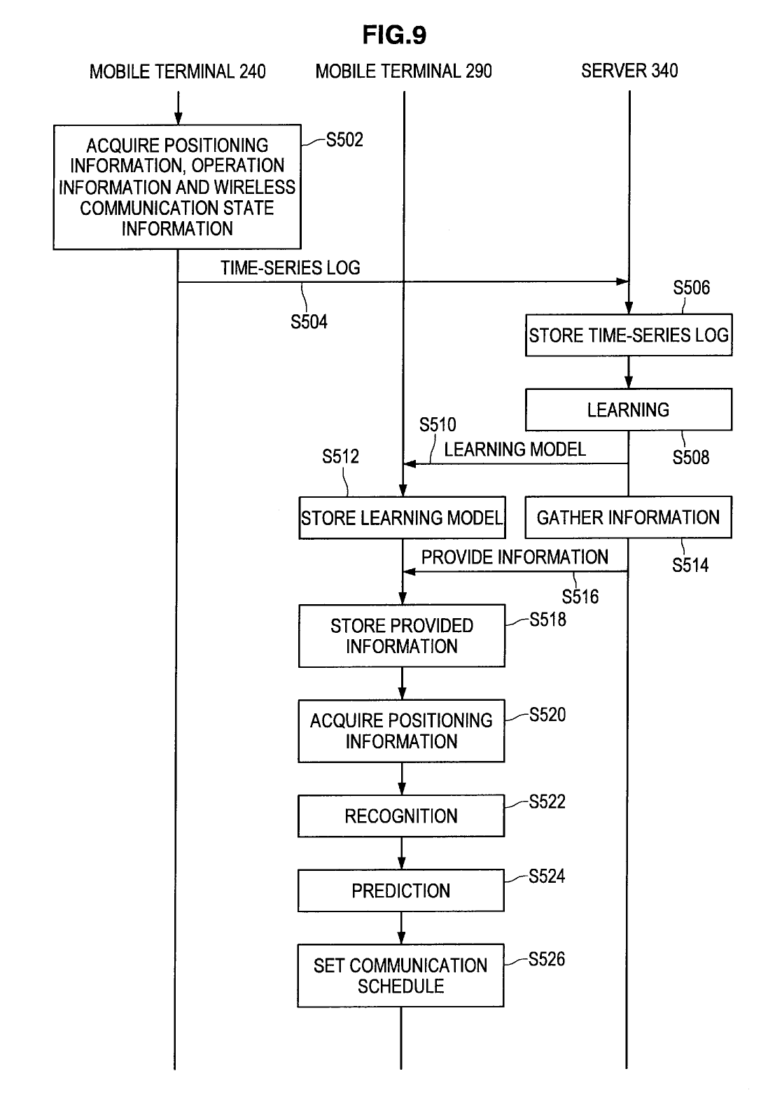

Next, a behavior prediction process executed by the behavior prediction system 140 in FIG. 7 will be described for a case where the behavior prediction system 140 includes two mobile terminals and one server. FIG. 9 is a sequence chart of the behavior prediction process executed by the behavior prediction system 140 in FIG. 7 for the case where the behavior prediction system 140 is constructed of two mobile terminals and one server.

In FIG. 9, first, the mobile terminal 240 acquires positioning information from the positioning unit 202, operation information received from the user via the operation unit 210, and the wireless communication state information for wireless communication between the mobile terminal 240 and the server 340 (step S502).

After this, the mobile terminal 240 transmits a log entry that includes the positioning information, the operation information, and the wireless communication state information acquired in step S502 or a time-series log in which such log entries have been accumulated for a certain period in a time series to the server 340 (step S504).

Next, the time-series log storage unit 302 of the server 340 stores the log transmitted from the mobile terminal 240 in step S504 or the time-series log(step S506).

After this, the behavior learning unit 304 of the server 340 learns, as the stochastic state transition model, the activity state of the user carrying the mobile terminal 240 in which the positioning unit 202 is incorporated based on the time-series log stored in the time-series log storage unit 302 (step S508).

Next, the behavior learning unit 304 of the server 340 transmits the parameters of the stochastic state transition model obtained by the learning process to the mobile terminal 290 (step S510).

After this, the mobile terminal 290 stores the stochastic state transition model of the parameters received in step S510 (step S512).

Meanwhile, the server 340 uses the stochastic state transition model of the parameters obtained by the learning process to gather information desired by the user based on the activity state of the user from the Internet or the like (step S514).

After this, the server 340 transmits the information desired by the user gathered in step S514 to the mobile terminal 290 (step S516).

Next, the mobile terminal 290 stores the information desired by the user received in step S516 (step S518).

After this, the behavior recognition unit 204 of the mobile terminal 290 acquires the positioning information from the positioning unit 202 (step S520).

Next, the behavior recognition unit 204 of the mobile terminal 290 uses the stochastic state transition model of the parameters obtained by the learning to recognize the present activity state of the user, that is, the present location of the user, from the positioning information acquired from the positioning unit 202 (step S522). The behavior recognition unit 204 supplies the node number of the present state node of the user to the behavior prediction unit 206.

After this, the behavior prediction unit 206 of the mobile terminal 290 uses the stochastic state transition model of the parameters obtained by the learning to precisely search for (predict) routes that may be taken by the user from the present location of the user shown by the node number of the state node supplied from the behavior recognition unit 204 (step S524). Also, by calculating the occurrence probability for each of the found routes, the behavior prediction unit 206 predicts a selection probability that is the probability that each found route will be selected. The destination prediction unit 208 is then supplied from the behavior prediction unit 206 with the routes that can be taken by the user and the respective selection probabilities and uses the stochastic state transition model of the parameters obtained by the learning to predict destinations of the user. More specifically, the destination prediction unit 208 first lists destination candidates. The destination prediction unit 208 sets places where the recognized behavior state of the user becomes a visit state as destination candidates. After this, out of the listed destination candidates, the destination prediction unit 208 decides destination candidates on the routes found by the behavior prediction unit 206 as destinations. In addition, the destination prediction unit 208 calculates an arrival probability for each decided destination. When the destinations to be displayed have been decided, the destination prediction unit 208 then calculates the arrival times for routes to the destinations and displays such information on the display unit 212.

Next, the communication schedule setting unit 216 of the mobile terminal 290 sets a communication schedule based on the information on the present location of the user recognized in step S522 so as to acquire information, which is desired by the user and is likely to be acquired by a user operation on a route that may be taken by the user, at a location on the route where the state of the wireless network is favorable (step S526), and ends the present process.

According to the behavior prediction process in FIG. 9, since the mobile terminal 290 stores the parameters of the stochastic state transition model obtained by the learning process at the server 340 and carries out the prediction process using the stochastic state transition model for the stored parameters, compared to when the prediction process is carried out using all of the past movement history, it is possible to reduce the processing load of the mobile terminal 290. Also, by receiving the parameters for the stochastic state transition model from the server 340 when the wireless communication state is favorable and storing such parameters, it is possible for the mobile terminal 290 to carry out the prediction process even when the wireless communication state is poor. In addition, by setting a communication schedule so as to acquire information, which is desired by the user and is likely to be acquired by a user operation on a route that may be taken by the user, at a location on the route where the state of the wireless network is favorable, it becomes possible to provide information to the user even when the wireless communication state is poor.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

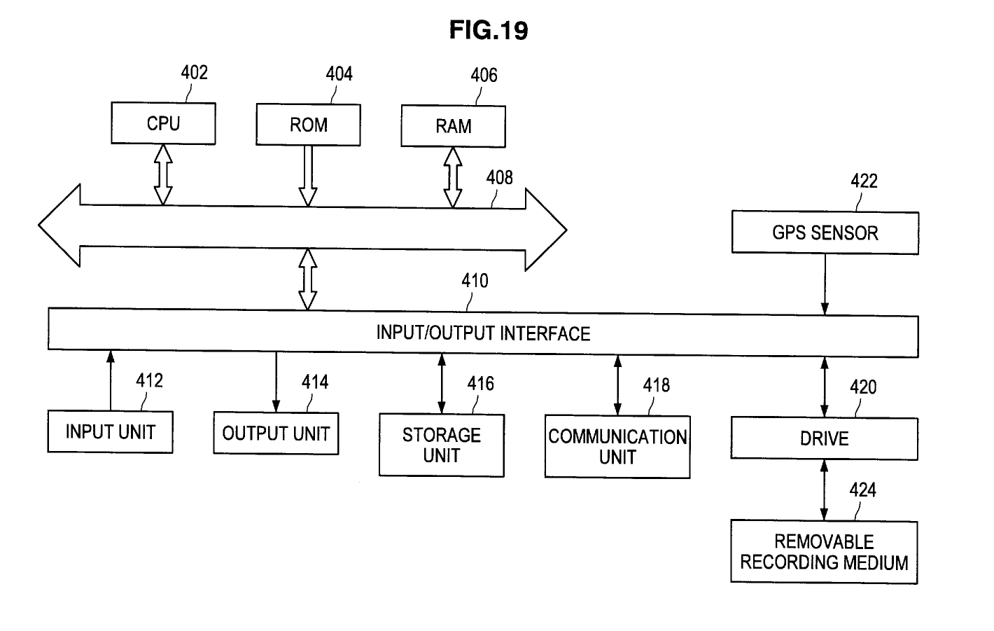

FIG. 19 is a block diagram showing an example configuration of the hardware of a computer that executes the series of processes described earlier according to a program.

In such computer, a CPU (Central Processing Unit) 402, a ROM (Read Only Memory) 404, and a RAM (Random Access Memory) 406 are connected to one another by a bus 408.

An input/output interface 410 is also connected to the bus 408. An input unit 412, an output unit 414, a storage unit 416, a communication unit 418, a drive 420, and a GPS sensor 422 are connected to the input/output interface 410.

The input unit 412 is composed of a keyboard, a mouse, a microphone, and the like. The output unit 414 is composed of a display, speakers, and the like. The storage unit 416 is composed of a hard disk drive, a nonvolatile memory, and the like. The communication unit 418 is composed of a network interface. The drive 420 drives a removable recording medium 424 such as a magnetic disk, an optical disk, a magneto-optical disk, a semiconductor memory, or the like. The GPS sensor 422 corresponds to the positioning unit 202 in FIG. 1.

In the computer configured as described above, as one example the CPU 402 loads a program stored in the storage unit 416 via the input/output interface 410 and the bus 408 into the RAM 406 and executes the program to carry out the series of processes described earlier.

As one example, the program executed by the computer (the CPU 402) may be provided by being recorded on the removable recording medium 424 as a packaged medium or the like. The program can also be provided via a wired or wireless transfer medium, such as a local area network, the Internet, or a digital satellite broadcast.

In the computer, by loading the removable recording medium 424 into the drive 420, the program can be installed into the storage unit 416 via the input/output interface 410. It is also possible to receive the program from a wired or wireless transfer medium using the communication unit 418 and install the program into the storage unit 416. As another alternative, the program can be installed in advance into the ROM 404 or the storage unit 416.

Note that the program executed by the computer may be a program in which processes are carried out in a time series in the order described in this specification or may be a program in which processes are carried out in parallel or at necessary timing, such as when the processes are called.

Note that steps written in the flowcharts accompanying this specification may of course be executed in a time series in the illustrated order, but such steps do not need to be executed in a time series and may be carried out in parallel or at necessary timing, such as when the processes are called.

Note also that in the present specification, the expression “system” refers for example to an entire configuration composed of a plurality of devices.

Although preferred embodiments of the present invention have been described in detail with reference to the attached drawings, the present invention is not limited to the above examples. It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-143650 filed in the Japan Patent Office on 24 Jun. 2010, the entire content of which is hereby incorporated by reference.

What is claimed is:

1. An information processing apparatus comprising:
a positioning unit acquiring positioning information on a latitude and longitude showing a position of the positioning unit;
a transmission unit transmitting a time-series log, which includes the positioning information acquired by the positioning unit, to a server;
a reception unit receiving an activity model showing an activity state of a user, the activity model being obtained by a learning process carried out by the server based on the time-series log;
a recognition unit recognizing a present activity state of the user using the positioning information acquired by the positioning unit and the activity model received by the reception unit; and
a prediction unit predicting behavior of the user from the present activity state of the user recognized by the recognition unit.

2. An information processing apparatus according to claim 1,
wherein the time-series log includes information on a wireless communication state of wireless communication between the information processing apparatus and the server.

3. An information processing apparatus according to claim 2,
wherein the transmission unit is operable to transmit the latest time-series log to the server when it is recognized, based on the activity model previously received by the reception unit, that wireless communication is possible between the information processing apparatus and the server.

4. An information processing apparatus according to claim 2,
wherein the reception unit is operable to receive the latest activity model when it is recognized, based on the activity model previously received by the reception unit, that wireless communication is possible between the information processing apparatus and the server.

5. An information processing apparatus according to claim 1,
wherein the time-series log includes operation information of the user of the information processing apparatus.

6. An information processing apparatus according to claim 1, further comprising:
an information reception unit receiving information that is desired by the user based on the activity state of the user and has been gathered by the server using the activity model; and
an information deciding unit using the positioning information acquired by the positioning unit and the information desired by the user received by the information reception unit to decide information to be provided to the user out of the information desired by the user received by the information reception unit.

7. An information processing apparatus according to claim 6,
wherein the information deciding unit also uses a prediction result of the prediction unit to decide, as the information to be provided to the user, information relating to a destination or a location en route to a destination of the user out of the information desired by the user received by the information reception unit.

8. An information processing apparatus according to claim 6,
wherein the time-series log includes information on a wireless communication state of wireless communication between the information processing apparatus and the server, and
the information reception unit is operable to receive the latest information desired by the user when it is recognized, based on the activity model previously received by the reception unit, that wireless communication is possible between the information processing apparatus and the server.

9. An information processing apparatus according to claim 2,
further comprising a setting unit setting a communication schedule so that information desired by the user is acquired when it is recognized, based on the activity model previously received by the reception unit, that wireless communication is possible between the information processing apparatus and the server.

10. An information processing apparatus according to claim 1,
wherein the reception unit receives an activity model which shows the activity state of the user and has been obtained by a learning process by the server based on a time-series log including positioning information acquired by a positioning unit of another information processing apparatus.

11. An information processing system comprising:
an information processing apparatus; and
a server,
the information processing apparatus including
a positioning unit acquiring positioning information on a latitude and longitude showing a position of the positioning unit,
a transmission unit transmitting a time-series log, which includes the positioning information acquired by the positioning unit, to the server,
a reception unit receiving an activity model showing an activity state of a user, the activity model being obtained by a learning process carried out by the server based on the time-series log,
a recognition unit recognizing a present activity state of the user using the positioning information acquired by the positioning unit and the activity model received by the reception unit, and
a prediction unit predicting behavior of the user from the present activity state of the user recognized by the recognition unit, and
the server including
a server-side reception unit receiving the time series log transmitted from the transmission unit,
a learning unit learning, as an activity model, an activity state of the user who carries the information processing apparatus based on the time series log received by the server-side reception unit, and
a server-side transmission unit transmitting the activity model obtained by the learning unit to the information processing apparatus.

12. An information processing method comprising steps of:
acquiring, by an information processing apparatus, positioning information on a latitude and longitude showing a position of the information processing apparatus;
transmitting, by the information processing apparatus, a time-series log, which includes the acquired positioning information, to a server;
receiving, by the server, the transmitted time series log;
learning, by the server, as an activity model, an activity state of the user who carries the information processing apparatus based on the received time series log;
transmitting, by the server, the obtained activity model to the information processing apparatus;
receiving, by the information processing apparatus, the transmitted activity model;
recognizing, by the information processing apparatus, a present activity state of the user using the acquired positioning information and the received activity model; and
predicting, by the information processing apparatus, behavior of the user from the recognized present activity state of the user.

13. A program for causing a computer to function as:
a positioning unit acquiring positioning information on a latitude and longitude showing a position of the positioning unit;
a transmission unit transmitting a time-series log, which includes the positioning information acquired by the positioning unit, to a server;
a reception unit receiving an activity model showing an activity state of a user, the activity model being obtained by a learning process carried out by the server based on the time-series log;
a recognition unit recognizing a present activity state of the user using the positioning information acquired by the positioning unit and the activity model received by the reception unit; and
a prediction unit predicting behavior of the user from the present activity state of the user recognized by the recognition unit.
